(19) United States
(12) Patent Application Publication
(10) Pub. No.: US 2007/0076556 A1
(43) Pub. Date: Apr. 5, 2007

(54) OPTICAL DISC DEVICE AND METHOD FOR DETECTING DEFECT ON OPTICAL DISC

(76) Inventor: Junichi Morimura, Sagamihara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/536,212

(22) Filed: Sep. 28, 2006

(30) Foreign Application Priority Data
Sep. 30, 2005 (JP) 2005-288759

(51) Int. Cl. G11B 20/10

(52) U.S. Cl. 369/59.22

(57) ABSTRACT

An optical disc device includes a pickup head which reads data recorded on an optical disc used by an optical beam to output a reproduction signal, an equalizer which equalizes a waveform of the reproduction signal in accordance with an equalization coefficient to output a partial response waveform, a maximum likelihood decoder which executes maximum likelihood decoding on the partial response waveform generated by the equalizer to generate a bit sequence, an ideal signal output section which generates an ideal signal from the bit sequence, an equalization error generating section which generates an equalization error signal from the ideal signal and the partial response waveform, an equalization coefficient calculating section which calculates the equalization coefficient by correlating the equalization error signal with the reproduction signal, and a defect detector which detects whether or not the optical disc has any defect, on the basis of the equalization error signal.

### CROSS-REFERENCE TO RELATED APPLICATIONS

This application is based upon and claims the benefit of priority from prior Japanese Patent Application No. 2005-288759, filed Sept. 30, 2005, the entire contents of which are incorporated herein by reference.

### BACKGROUND OF THE INVENTION

1. Field of the Invention

The present invention relates to an optical disc device that detects a defect on an optical disc while data is being reproduced from the optical disc, as well as a method for detecting a defect on an optical disc.

2. Description of the Related Art

If an optical disc has any defect, it is difficult to achieve normal reproduction. Accordingly, a detecting operation is performed to check whether or not an optical disc has any defect. If the optical disc has a defect, gain adjustment or the like is carried out to enable the normal reproduction. Defect detection is conventionally carried out using the envelope of a reproduction signal (RF signal) (Jpn. Pat. Appln. KOKAI Publication No. 2005-141868).

With the conventional defect detection using the envelope of the RF signal, a small defect results in an unmarked change in RF signal. This disadvantageously precludes the defect from being detected.

### BRIEF SUMMARY OF THE INVENTION

An aspect of the present invention provides an optical disc device comprises a pickup head which reads data recorded on an optical disc used by an optical beam to output a reproduction signal, an equalizer which equalizes a waveform of the reproduction signal in accordance with an equalization coefficient to output a partial response waveform, a maximum likelihood decoder which executes maximum likelihood decoding on the partial response waveform generated by the equalizer to generate a bit sequence, an ideal signal output section which generates an ideal signal from the bit sequence generated by the maximum likelihood decoder, an equalization error generating section which generates an equalization error signal from the ideal signal generated by the ideal signal output section and the partial response waveform generated by the equalizer, an equalization coefficient calculating section which calculates the equalization coefficient by correlating the equalization error signal generated by the equalization error generating section with the reproduction signal, and a defect detector which detects whether or not the optical disc has any defect, on the basis of the equalization error signal generated by the equalization error generating section.

### BRIEF DESCRIPTION OF THE SEVERAL VIEWS OF THE DRAWING

FIG. 1 is a perspective view schematically showing the structure of an optical disc device in accordance with an embodiment of the present invention;

FIG. 2 is a block diagram showing the configuration of an optical pickup in the optical disc device shown in FIG. 1;

FIG. 3 is a diagram showing circuit blocks including a pickup shown in FIG. 2;

FIG. 4 is a block diagram showing a system which reproduces data from HD DVD and which detects defects;

FIG. 5 is a diagram showing an optical disc having a defect;

FIG. 6 is a diagram showing an equalization error signal obtained if the defect part is reproduced;

FIG. 7 is a block diagram showing an example of a defect detector;

FIG. 8 is a diagram showing an example of a defect detection waveform output by the defect detector; and

FIG. 9 is a diagram showing the envelope waveform of an RF signal obtained when the pickup passes over the defect.

### DETAILED DESCRIPTION OF THE INVENTION

Description will be given of an optical disc device that can reproduce data from HD DVD (High Definition Digital Versatile Disc) media.

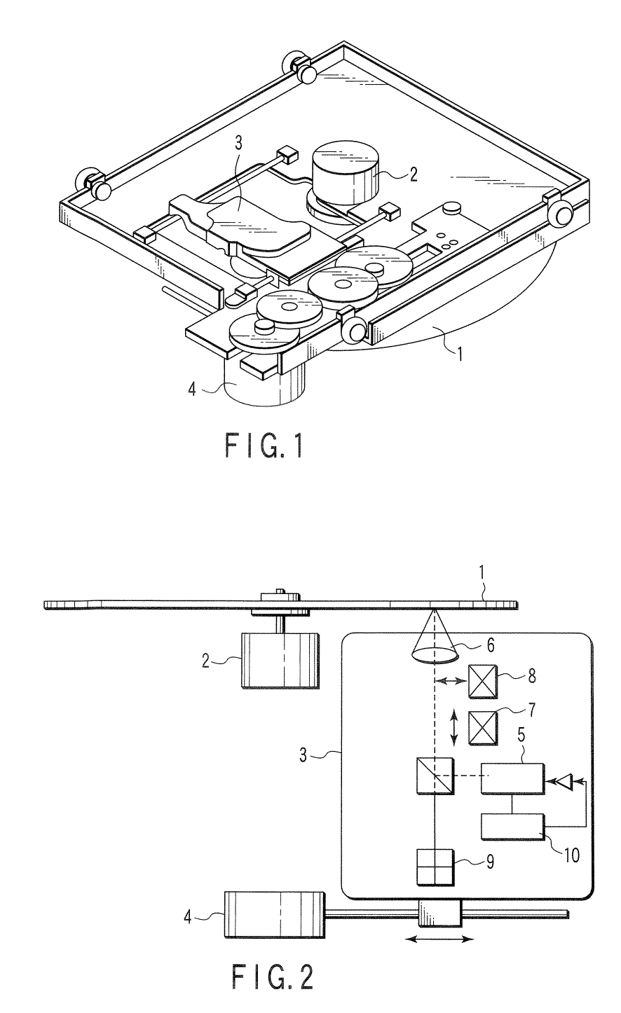

FIG. 1 is a diagram schematically showing the structure of an optical disc device in accordance with a first embodiment of the present invention. FIG. 2 is a block diagram showing the configuration of an optical pickup integrated into the optical disc device.

The optical disc device in accordance with the present embodiment is mainly composed of a spindle motor 2 that rotatively drives the optical disc 1, a optical pickup 3 that reads signals recorded on the optical disc 1, a feed motor 4 that moves the optical pickup 3 in a radial direction of the optical disc 1, and a main board on which a microcomputer, a signal processing circuit, and the like are mounted. The feed motor 4 is provided with sensing section for sensing the rotational conditions of the motor such as the rotating frequency, speed, and direction of the motor. A feed motor driving signal circuit uses an output signal from the sensing signal to control the feed motor during track search.

As shown in FIG. 2, the optical pickup 3 is mainly provided with light emitting diode 5 that outputs a laser beam, an objective lens 6 supported by a wire or blade spring (not shown) and which focuses the laser beam emitted by the light emitting diode 5 on a surface of the optical disc 1, which is thus irradiated with the laser beam, a focusing coil 7 and a tracking coil 8 which controllably moves the objective lens 6 in a focus direction and a tracking direction, respectively, a detector 9 that receives the reflected beam from the optical disc 1, and a monitor detector 10 which monitors the reflected beam from the optical disc 1 and which feeds back data to the light emitting diode 5.

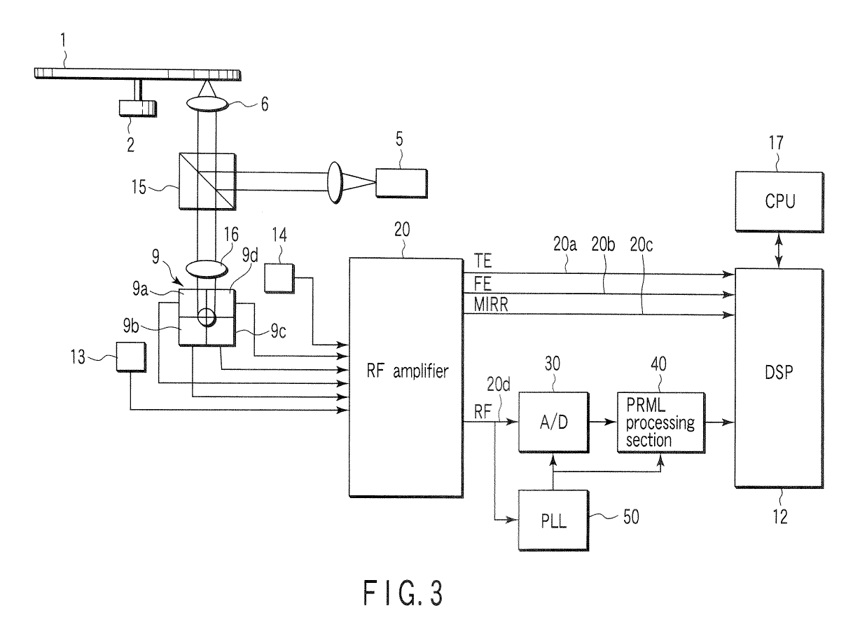

FIG. 3 is a diagram showing circuit blocks including the pickup 3. The circuit has an RF amplifier 20 to which a signal read by the optical pickup 3 is supplied and DSP (Digital Signal Processor) 12 to which a signal amplified by the RF amplifier 20 is supplied.

As shown in FIG. 3, the optical pickup 3, connected to the RF amplifier 20, has a 4-divided photodetector 9 and sub-beam detectors 13 and 14 that create track error signals for CD. The optical pickup 3 further has a light emitting diode 5 that emits a laser beam with which the optical disc 1 is irradiated, a splitter 15 that separates the generated laser beam from the reflected beam from the optical disc 1, the objective lens 6, and a condenser lens 16 placed in front of the 4-divided photodetector 9.

The optical disc 1 is irradiated, via the splitter 15 and objective lens 6, with an optical beam emitted by the light emitting diode 5. A reflected beam from the optical disc 1 is guided to the 4-divided photodetector 9 via the objective lens 6, splitter 15, and condenser lens 16.

The 4-divided photodetector 9 consists of a 4-divided light receiving element including photo-detecting cells 9a, 9b, 9c, and 9d.

Outputs from the photo-detecting cells 9a, 9b, 9c, and 9d and sub-beam detectors 13 and 14 are input to the RF amplifier 20. The RF amplifier 20 then amplifies and subjects the signals to an addition and a subtraction to output a tacking error signal (TE) 20a, a focus error signal (FE) 20b, an RF signal 20d, and a MIRR signal 20c.

The tracking error signal (TE) 20a and focus error signal (FE) 20b are servo signals from the optical disc 1 which are used to perform servo operations of tracking and focusing the objective lens 6. The RF signal 20d is a read reproduction data signal. The MIRR signal 20c indicates the envelope of the RF signal 20d.

The RF amplifier 20 adds together and amplifies output signals from the photo-detecting cells 9a, 9b, 9c, and 9d of the photodetector 9 to output an RF signal 20d.

That is, when the outputs from the photo-detecting cells 9a, 9b, 9c, and 9d are defined as A, B, C, and D, the RF amplifier 20 uses a signal RF=A+B+C+D to generate a high frequency RF signal 20d.

Similarly, the RF amplifier 20 uses a signal FE=(A+C)−(B+D) to generate a focus error signal (FE) 20b. The RF amplifier 20 also uses a signal TE=(A+B)−(C+D) to generate a tracking error signal (TE) 20a.

The MIRR signal 20c is produced by sensing the peak and bottom of the RF signal 20d waveform to execute the calculation {(peak)−(bottom)}. When a lens jump occurs, that is, when the driving coil 8 is used to move the objective lens 6 a distance corresponding to a plurality of tracks in the tracking direction, the MIRR signal 20c is used to check the actual number of tracks corresponding to the distance the lens has moved.

The track error signal (TE) 20a for CD playing is produced by calculating the difference (E−F) between an output current E from the sub-beam detector 13 and an output current F from the sub-beam detector 14.

DSP 12 is connected to CPU 17 and operates on the basis of instructions from CPU 17.

Now, adjustment of RF amplitude will be described. RF amplitude adjustment in optical disc equipment is intended to achieve a target RF amplitude value on the basis of the MIRR signal 20c. Specifically, an AD converter in DSP 12 reads the current MIRR signal level and compares it with a preset target value. On the basis of the comparison, the AD converter then adjusts the RF amplitude of the RF amplifier 20.

An RF signal 20d amplified by the RF amplifier 20 is supplied to a PLL circuit 50 and an A/D converter 30. The A/D converter 30 digitally converts the supplied RF signal 20d and supplies the resulting signal to a PRML processing section 40. The PRML processing section 40 executes a PRML process on the signal and supplies the resulting signal to DSP 12.

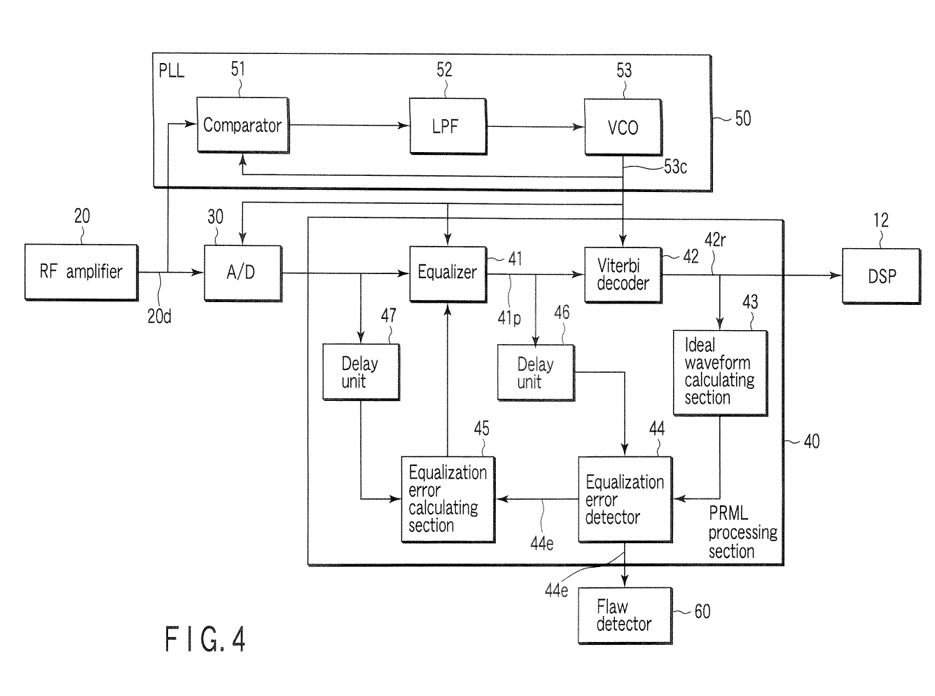

With reference to FIG. 4, description will be given of the PLL circuit 50, the PRML processing section 40, and a system configuration for detecting a defect on the optical disc 1.

In the PLL circuit 50, the RF signal 20d digitally converted by the A/D converter 30 is input to a phase comparator 51. The phase comparator 51 compares the RF signal 20d with a comparison signal output by a voltage control oscillator (VCO) 53. The phase comparator 51 then outputs a phase difference component as a pulse-like phase difference signal. The phase difference signal has its high frequency component blocked by a loop filter (integration circuit/low pass filter) 52. The phase difference signal is thus converted into a DC signal, which is then input to the voltage control oscillator 53. The voltage control oscillator 53 has a specified free-running frequency to vary oscillation frequency depending on the phase difference signal. On the basis of the input signal, the voltage control oscillator 53 adjusts the oscillation frequency to output a clock signal 53c. The clock signal 53c is supplied to the phase comparator 51; the clock signal 53c corresponds to a comparison signal. The clock signal 53c output by the voltage control oscillator 53 is supplied to the A/D converter 30 and PRML processing section 40.

The RF signal 20d is supplied by the RF amplifier 20 and then digitally converted by the A/D converter 30. The RF signal 20d is then supplied to the equalizer 41 in the PRML processing section 40. On the basis of an equalization coefficient calculated by an equalization coefficient calculating section 45, the equalizer 41 equalizes the RF signal 20d to obtain a partial response waveform 41p. Here, the target partial response waveform 41p is a PR value (1, 2, 2, 2, 1) or (3, 4, 4, 3). The PR value may have another pattern. The equalizer is driven by the clock signal 53c supplied by the PLL circuit 50.

The signal equalized by the equalizer 41 is supplied to a Viterbi decoder 42. The Viterbi decoder 42 is driven by the clock signal 53c supplied by the PLL circuit 50. The Viterbi decoder 42 executes maximum likelihood decoding on the partial response waveform 41p to obtain the reproduction signal 42r. The Viterbi decoder 42 then supplies the reproduction signal 42r to DSP 12 and an ideal waveform calculating section 43. The ideal waveform calculating section 43 converts the reproduction signal 42r into an ideal waveform. The ideal waveform obtained is supplied to an equalization error detector 44.

The equalization error detector 44 calculates the difference between the ideal waveform and a partial response waveform 41p supplied via a delay unit 46. The equalization error detector 44 then squares the error to obtain an evaluation function. The equalization error detector 44 then uses the evaluation function to generate an equalization error signal 44e. The equalization error signal 44e generated is supplied to the equalization coefficient calculating section 45. The delay unit 46 adjusts the partial response waveform 41p and the ideal waveform supplied by the ideal waveform calculating section 43 so that the waveforms are input to the equalization error detector 44 at the same time.

The equalization coefficient calculating section 45 calculates an equalization coefficient from the equalization error signal 44e generated by the equalization error detector 44 and a RF digital signal supplied by the A/D converter 30 via a delay unit 47. The equalization coefficient calculating section 45 supplies the calculated equalization coefficient to the equalizer 41.

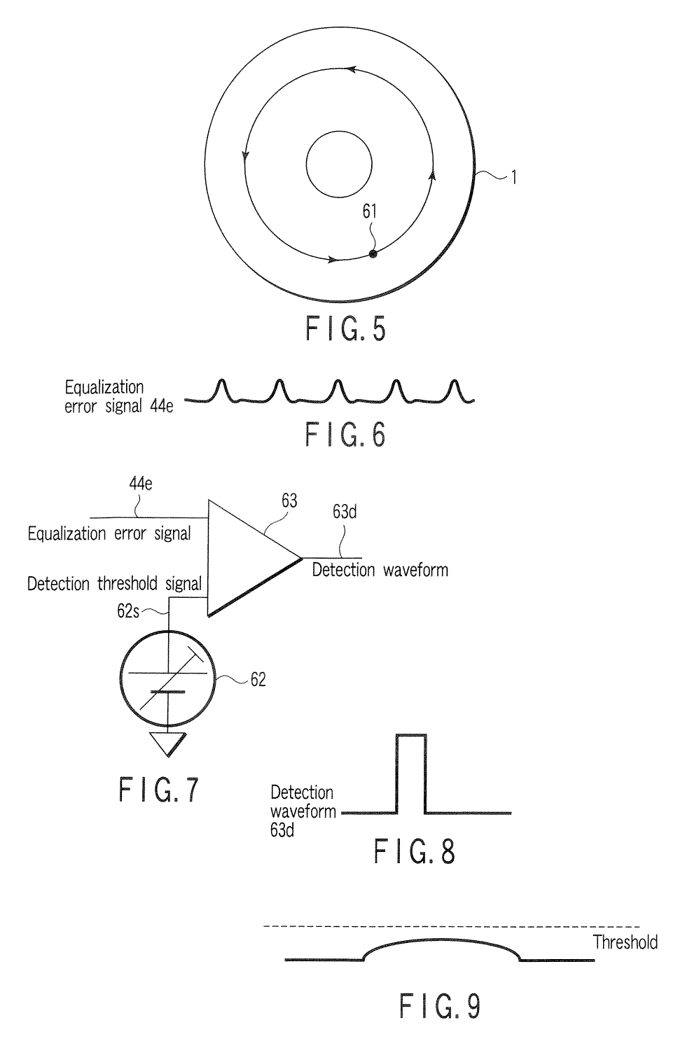

Further, the equalization error signal 44e generated by the equalization error detector 44 is supplied to a defect detector 60. As shown in FIG. 5, the optical disc 1 has a defect part 61. Reproduction of the defect part 61 increases the magnitude of the equalization error signal 44e in the defect part 61. This is because the defect part 61 makes the actual waveform of the reproduced signal far from the ideal waveform. On the basis of this characteristic, the defect detector 60 detects defects using the equalization error signal 44e.

When the magnitude of output of the equalization error signal 44e increases up to a specified value, the defect detector 60 determines that the optical disc 1 has a defect. The defect detector 60 then executes, for example, a process of holding the signal or setting a fixed signal, on the servo system only during passage over the defect. In some cases, the defect detector 60 also executes, for example, a process of holding a PLL circuit operation signal system, on the PLL circuit 50 during the passage over the defect. If the RF amplifier 20 internally executes an automatic amplitude adjusting process such as AGC (Auto Gain Control) on the RF signal 20d, the AGC circuit must also be held.

FIG. 7 shows an example of the defect detector 60. The defect detector 60 has a detection threshold signal adjustor 62 that generates a detection threshold signal 62s to adjust the magnitude of the detection threshold signal 62s, and a comparator 63 to which the equalization error signal 44e and the detection threshold signal 62s are input. The comparator 63 compares the magnitude of the equalization error signal 44e with the magnitude of the detection threshold signal 62s. If the equalization error signal 44e has a larger magnitude than the detection threshold signal 62s, the comparator 63 outputs a detection waveform 63d corresponding to “Hi” as shown in FIG. 8.

The equalization error signal 44e is more sensitive to defects than the RF signal 20d. The equalization error signal 44e thus responds quickly to a defect and changes to a signal such as the one shown in FIG. 6. Thus, in contrast to the conventional process of detecting a defect using the RF signal 20d, the present process can detect even a small defect. The present process can also deal adequately with a small defect as described above for the process executed upon detection of a defect (gain adjustment, signal hold, or the like). Furthermore, defects can be detected more quickly.

If defects are detected using the envelope signal of the RF signal 20d as in the case of the prior art, the envelope signal of the RF signal 20d is as shown in FIG. 9 when the pickup passes over a small defect. A broken line in the figure indicates a detection level (threshold). The RF signal 20d tends to have its output level reduced by a change in the quantity of light upon passage over a defect. For a large defect, the quantity of light decreases sufficiently to change the output to a level at which it can be detected. However, for a small defect, only a small change appears; the change in the magnitude of the signal does not reach the detection level (threshold) as shown in FIG. 9. Normally, such a change may lead to a misdetection if the RF signal 20d is disturbed by a servo factor. Accordingly, such a change is not detected.

In contrast, the equalization error signal 44e uses the evaluation function, obtained by squaring an error. Accordingly, even a small defect results in the error signal of a large value. This enables even a small defect to be successfully detected and also makes it possible to respond immediately to the defect.

The above technique for detecting the presence of a defect from the equalization error signal 44e is applicable to any device that uses PRML to reproduce data recorded on an optical disc. The technique is applicable to, for example, detection of a defect on an optical disc conforming to the Blu-ray standard.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc device comprising:
a pickup head which reads data recorded on an optical disc used by an optical beam to output a reproduction signal;
an equalizer which equalizes a waveform of the reproduction signal in accordance with an equalization coefficient to output a partial response waveform;
a maximum likelihood decoder which executes maximum likelihood decoding on the partial response waveform generated by the equalizer to generate a bit sequence;
an ideal signal output section which generates an ideal signal from the bit sequence generated by the maximum likelihood decoder;
an equalization error generating section which generates an equalization error signal from the ideal signal generated by the ideal signal output section and the partial response waveform generated by the equalizer;
an equalization coefficient calculating section which calculates the equalization coefficient by correlating the equalization error signal generated by the equalization error generating section with the reproduction signal; and
a defect detector which detects whether or not the optical disc has any defect, on the basis of the equalization error signal generated by the equalization error generating section.

2. The optical disc device according to claim 1, wherein the defect detector comprises:
threshold signal generating section which generates a threshold signal; and
a comparator which compares the magnitude of the equalization error signal with the magnitude of the threshold signal and which determines that the optical disc has a defect when the magnitude of the equalization error signal is larger than that of the threshold signal.

3. The optical disc device according to claim 1, wherein a partial response value (1, 2, 2, 2, 1) or (3, 4, 4, 3) is used as the partial response waveform.

4. A method for detecting a defect on an optical disc, the method comprising:
reading data recorded on an optical disc to output a reproduction signal;
equalizing a waveform of the reproduction signal in accordance with an equalization coefficient to generate a partial response waveform;
executing maximum likelihood decoding on the partial response waveform to generate a bit sequence;
generating an ideal signal from the bit sequence;
generating an equalization error signal from the ideal signal and the partial response waveform;
calculating the equalization coefficient by correlating the equalization error signal with the reproduction signal; and
detecting whether or not the optical disk has any defect, on the basis of the equalization error signal.

5. The method for detecting a defect on an optical disc according to claim 4, wherein the detection of a defect comprises:
comparing the magnitude of the equalization error signal with the magnitude of a threshold signal; and
determining that the optical disc has a defect when the magnitude of the equalization error signal is larger than that of the threshold signal.

6. The method for detecting a defect on an optical disc according to claim 4, wherein a partial response value (1, 2, 2, 2, 1) or (3, 4, 4, 3) is used as the partial response waveform.
